(19) United States
(12) Patent Application Publication
(10) Pub. No.: US 2006/0067681 A1
(43) Pub. Date: Mar. 30, 2006

(54) Photo film processing system

(75) Inventors: Takayuki Iida, Kanagawa (JP); Shigeru Ando, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/235,080

(22) Filed: Sep. 27, 2005

(30) Foreign Application Priority Data
Sep. 27, 2004 (JP) 2004-280248

(51) Int. Cl. G03B 13/00

(52) U.S. Cl. 396/567

(57) ABSTRACT

A bar code representative of a print order reception number is assigned to each filmstrip. An auto film loader is provided with a bar code reader to read the print order reception number from the filmstrip, and determines a film type of the existing filmstrip based on the print order reception number, before feeding the filmstrip to an image reading apparatus. A film sorter is disposed behind the image reading apparatus. If the filmstrip fed through the image reading apparatus is a negative film, a lid of the film sorter is closed to guide the filmstrip to a negative film cutter-inserter section. If the filmstrip fed through the image reading apparatus is not a negative film, a lid of the film sorter is opened to guide the filmstrip to a film catcher.

### FIELD OF THE INVENTION

The present invention relates to a photo film processing system that processes a strip of exposed photo film and ejects it in a condition to be handed back to a customer who ordered development and/or printing of the exposed photo filmstrip. More particularly, the present invention relates to a photo film processing system that can sort out individual strips of exposed photo film according to their types, such that negative filmstrips are fed to a negative film cutter-inserter, while other types are fed to a film accumulator or film catcher.

### BACKGROUND ARTS

As disclosed for example in Japanese Laid-open Patent Application No. 2002-128340, a photo film processing system is comprised of an auto film loader, an image reading apparatus and a negative film cutter-inserter. The negative film cutter-inserter automatically cuts a negative filmstrip into several pieces and inserts the pieces in sleeves of a plastic sleeve sheet, after the image reading apparatus reads images as recorded on the negative filmstrip.

The auto film loader of this prior art is constituted of a film holder holding a pile of filmstrips, a feed roller for feeding the filmstrips one by one from the pile to a film path, and conveyer rollers for conveying the filmstrip through the film path into the image reading apparatus. The image reading apparatus of the prior art is constituted of a scanner section consisting of a linear CCD sensor and a light source, a film conveyer mechanism for conveying the filmstrip from the auto film loader through the scanner section, an image processor for processing image data picked up through the scanner section, and a display section for displaying images based on the image data.

The film holder can hold both negative and reversal filmstrips insofar as they are 35 mm wide, so the auto film loader can feed both types of filmstrips into the image reading apparatus. Also the image reading apparatus can pick up image data from either type by adjusting operational conditions of the scanner section to the film type.

However, after the image reading, the filmstrips should be processed or treated differently depending upon the film type. For example, a negative filmstrip is cut into pieces and inserted into a sleeve sheet. On the other hand, a reversal filmstrip is received in a film catcher or film accumulator as disclosed in Japanese Laid-open Patent Application No. 5-224312, and thereafter cut into individual picture frames, which are inserted into slide carriers for slide projection.

Since most of the photo filmstrips to be processed in photo-labs are negative ones, the photo film processing systems installed in the photo-labs are constituted of an auto film loader, an image reading apparatus and a negative film cutter-inserter. Such a photo film processing system cannot process the reversal film unless it is modified. In order to process the reversal film with the conventional photo film processing system, an operator of the photo-lab must sort out reversal filmstrips from negative filmstrips, put only the reversal filmstrips in the film holder, and, after completing image-reading from negative filmstrips that presently exist in the photo film processing system, remove the negative film cutter-inserter and mount the film catcher instead.

The manual sorting between reversal and negative filmstrips, and the replacement of the negative film cutter-inserter with the film catcher consume certain labor and time, lowering the processing efficiency badly.

### SUMMARY OF THE INVENTION

In view of the foregoing, a primary object of the present invention is to provide a photo film processing system that can process different types of photo filmstrips at a high processing efficiency, without the need for manual sorting of the individual photo filmstrips, or replacing some component of the system.

To achieve the above and other objects, a photo film processing system of the present invention comprises an auto film loader for supplying a photo filmstrip automatically in a sequential fashion; a film working device for reading image data or making photo prints from picture frames of the photo filmstrips; a film type discrimination device for discriminating the photo filmstrips between a negative type and other types; and a sorting device disposed in a position downstream of the film working device, for sorting the photo filmstrips according to film types discriminated by the film type discrimination device.

According to a preferred embodiment, the photo film processing system further comprises a device for recording data on the filmstrips for allowing to discriminate the film type with reference to the data, and a sensor disposed in the film type discrimination device, for reading the data from the filmstrips.

According to another preferred embodiment, the film type discrimination device is an image processor that can discriminates the film type based on the image data read by the film wording device.

The sorting device preferably comprises a lid that forms a guide surface of a film path for guiding the photo filmstrips after being fed out from the film working device, a driving device for driving the lid to open and close, and a control device for controlling the driving device of the lid in accordance with the film type discriminated by the film type discrimination device, such that the lid is closed for the negative type filmstrips and is opened for other types of filmstrips, to distribute the photo filmstrips into two directions.

A negative film cutter-inserter is disposed in a position downstream of the sorting device, to cut the photo filmstrips into pieces and insert the pieces into preservation bags, wherein the sorting device feeds the photo filmstrip to the negative film cutter-inserter when the film type discrimination device discriminates the photo filmstrip as the negative type.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is a conceptual block diagram illustrating a photo film processing system of the present invention;

FIG. 2 is an explanatory diagram illustrating a sequence of film reception processes;

FIG. 3 is an explanatory diagram illustrating check tapes to be put on individual filmstrips;

FIG. 4 is a block diagram illustrating a film flow in the photo film processing system and a data flow for controlling the photo film processing system, according to an embodiment of the present invention;

FIG. 5 is a block diagram illustrating a data flow for controlling an auto film loader and an image reading apparatus of the photo film processing system;

FIG. 6 is a table showing current values conducted through LEDs on scanning a reversal film;

FIG. 7 is a perspective view illustrating a lid and a lid driving mechanism of a film sorter of the photo film processing system;

FIG. 8 is a perspective view illustrating an automatic negative film cutter-inserter;

FIG. 9 is a flowchart illustrating a control sequence of sorting the photo filmstrips according to their film types by switching between first and second film transport paths;

FIG. 10 is a flowchart illustrating a control sequence for switching to the first filmstrip transport path;

FIG. 11 is a flowchart illustrating a control sequence for switching to the second film transport path;

FIG. 12 is a flowchart illustrating a control sequence for controlling timing of outputting a film path switching signal;

FIG. 13 is a table illustrating a list of order data of the filmstrips stored in the order of print order reception numbers; and

FIG. 14 is a block diagram illustrating an image reading apparatus according to another embodiment of the present invention, wherein film type is determined by an image processor.

### DESCRIPTION OF THE PREFERRED EMBODIMENTS

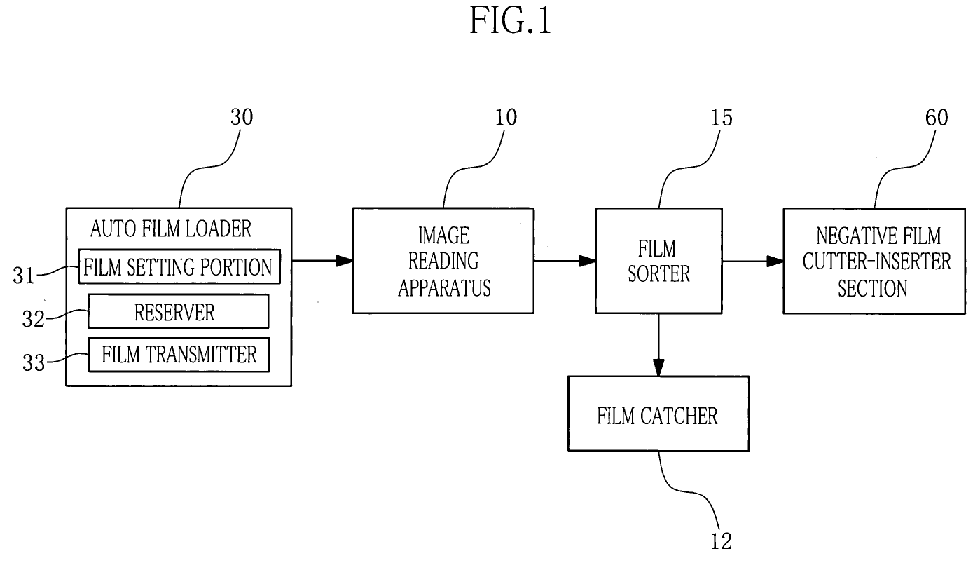

As shown in FIG. 1, a photo film processing system of the present invention consists of an auto film loader 30, an image reading apparatus 10, a film sorter 15, a negative film cutter-inserter section 60 and a film catcher 12. The film sorter 15 sorts photo filmstrips, sending negative films to the negative film cutter-inserter section 60 and the other films to the film catcher 12. The film sorter 15 and the film catcher 12 are built in a common casing to connect as a unit to the image reading apparatus 10. However, it is preferable to build the film sorter 15 and the film catcher 12 in the image reading apparatus 10, because the film sorter 15 is for changing transport direction of photo filmstrips according to film types.

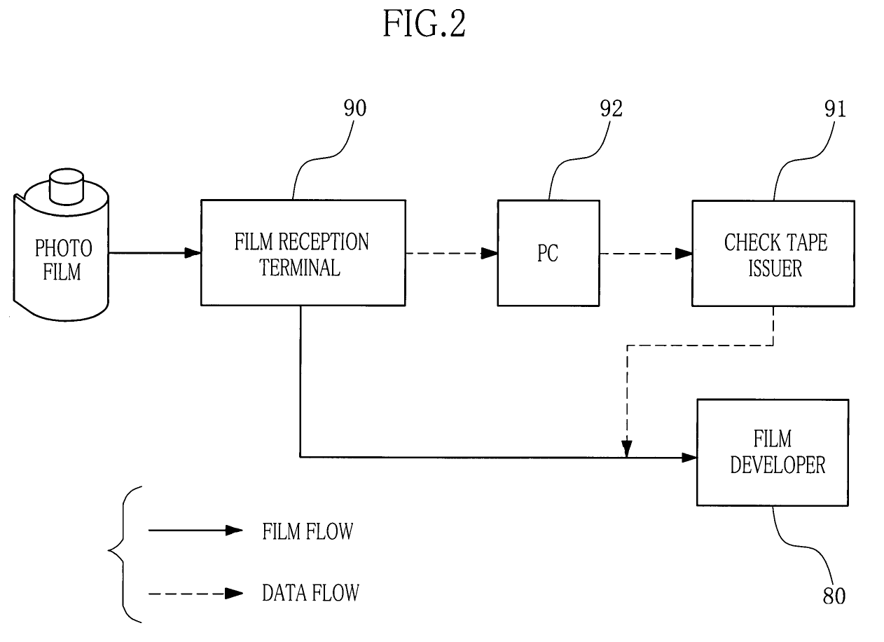

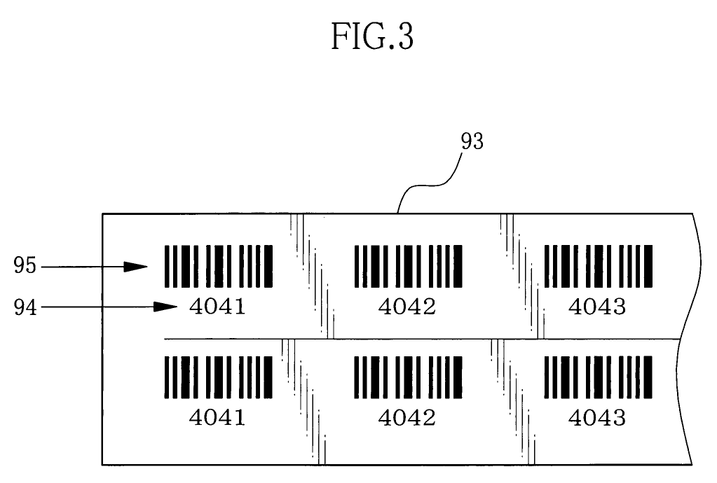

FIG. 2 illustrates a film reception process of the present invention. A photo film brought in a photo-lab is accepted at a film reception terminal 90. At the film reception terminal 90, an operator inputs order data including film type data into a computer 92 while having a conversation with a client. For this process, it is also possible to use a self-service receiver with which the client can apply to the reception themselves. Since the computer 92 is connected to a check tape issuer 91, a check tape 93 is issued from the check tape issuer 91 based on the order data input in the computer 92, and the operator places the check tape 93 at a leading end of the photo filmstrip. FIG. 3 shows an example of the check tapes 93. The check tape 93 is printed with a print order reception number so as to associate the input order data with the photo film brought in the photo-lab. The print order reception number consists of number data 94 for the operator to read and a mechanically readable code (bar code) 95. Having finished the reception at the film reception terminal 90, the photo filmstrip with the check tape 93 at its leading end is developed in a film developer 80 and, thereafter, set in the auto film loader 30.

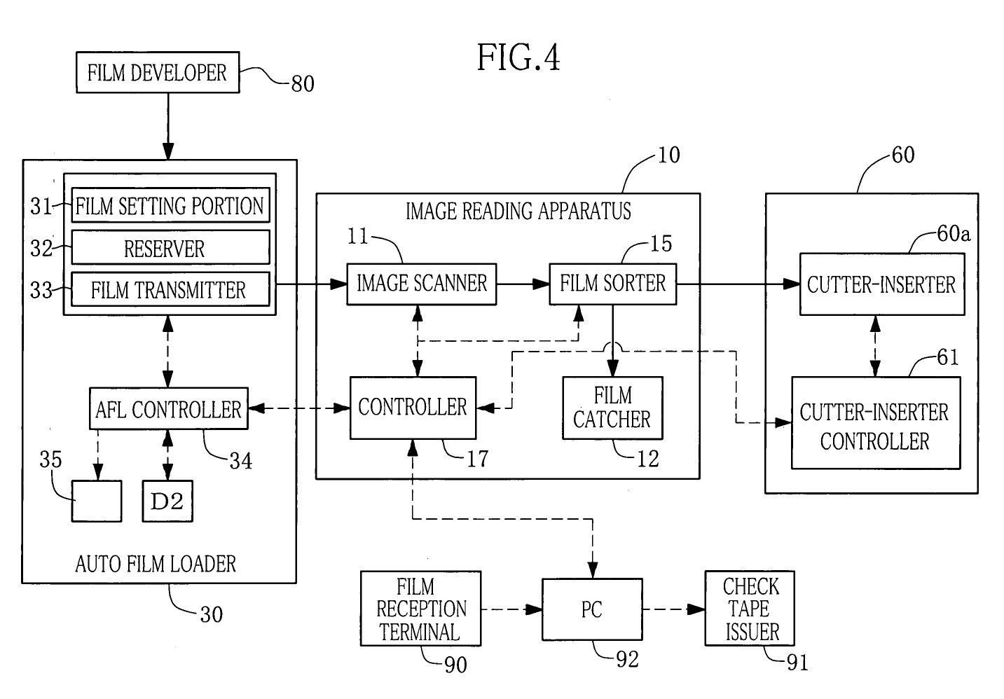

As shown in FIG. 4, the auto film loader 30 consists of a film setting portion 31, a reserver 32, a film transmitter 33, an auto film loader controller 34 and an alarm 35. The image reading apparatus is provided with an image scanner 11 and a controller 17 which is connected to the auto film loader controller 34 and the computer 92. The photo film developed in the film developer 80 is set in the film setting portion 31 of the auto film loader 30. A bar code reader D2 reads the bar code 95 on the check tape 93 put on the photo filmstrip, and the auto film loader controller 34 decodes the bar code data, as being input from the bar code reader D2, into the print order reception number, and sends the decoded data to the controller 17. In the present embodiment, the film sorter 15 and the film catcher 12 are built in the image reading apparatus 10.

The controller 17 searches for the order data in the computer 92 based on the print order reception number and, based on the order data, retrieves the film type data of the photo film that is fed from the film setting portion 31 to the reserver 32. Based on the retrieved film type data, the controller 17 sends a command to the image scanner 11 to change a scanning condition according to the film type of the next photo film which is to be fed to the image reading apparatus 10, and also a command to the film sorter 15 according to the film type.

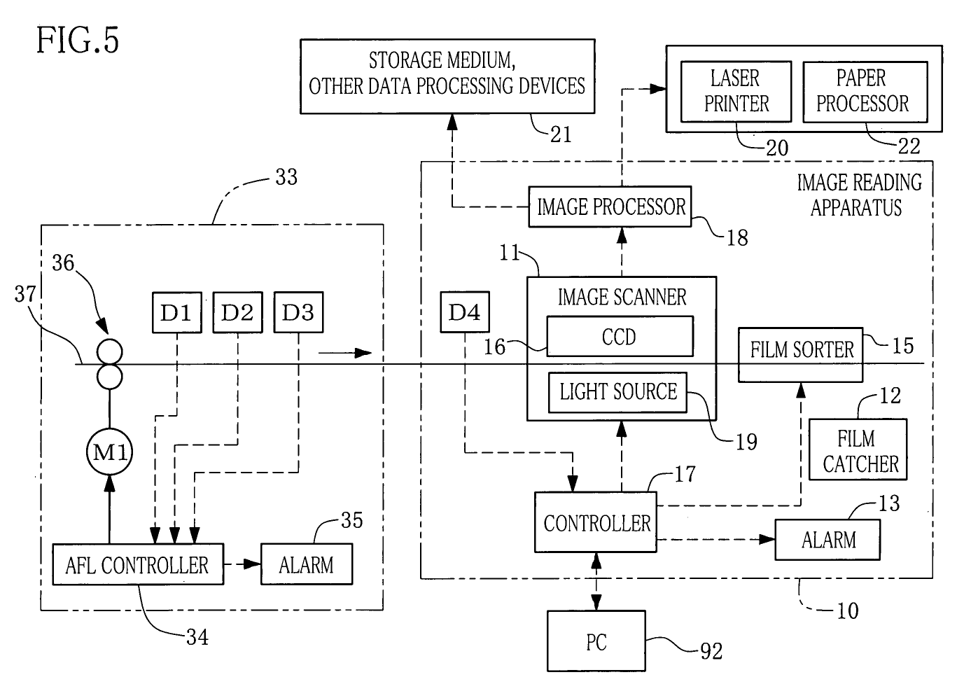

FIG. 5 is a control diagram between the film transmitter 33 of the auto film loader 30 and the image reading apparatus 10. The film transmitter 33 is provided with a conveyer motor M1, a pair of conveyer rollers 36 and film detectors D1 and D3. The auto film loader controller 34 drives the pair of conveyer rollers 36 by controlling the conveyer motor M1 and conveys the photo film along a film path 37 from the reserver 32 to the image reading apparatus 10 via the film transmitter 33. The bar code reader D2 scans the bar code 95 on the check tape 93. When the bar code is decoded right, the bar code reader D2 stops scanning and outputs a scanning completion signal to the auto film loader controller 34. After the film detector D3 detects the photo film, the auto film loader controller 34 stops the conveyer motor M1.

When a demand signal for feeding out the photo film is received from the controller 17 of the image reading apparatus 10 onto the auto film loader controller 34, it controls the auto film loader 33 to feed the photo filmstrip to the image reading apparatus 10. Conveyer rollers (unshown in the drawings) in the image scanner 11 receive the photo filmstrip. A film detector D4 of the image reading apparatus 10 is to detect leading and trailing ends of the photo filmstrip fed out from the film transmitter 33. A signal of the film detector D4 changes from a low level to a high level when detecting the leading end of the photo filmstrip, and from the high level to the low level when detecting the trailing end.

The image scanner 11, which reads film images recorded on the photo filmstrips including negative and reversal filmstrips, consists of a CCD sensor 16 and a light source 19. The CCD sensor 16 has an imaging optical system, an area CCD and a pixel shift mechanism. The light source 19 consists of red, green, blue and infrared light sources, each consisting of a plural number of LEDs (light emitting diodes) that emit red, green, blue and infrared light respectively. Time-sharing illumination of four-color LED light sources allows reading the image on the photo filmstrip in a color separation method, and the respective image data of the separated colors are output to an image processor 18. The infrared light is used for compensating damages.

The image processor 18 executes image processing on the image data read by the image reading apparatus 10 and outputs it as image recording data to a laser printer 20. The image processor 18 also outputs the processed image data as an image file to outside for example outputting to a storage medium such as a memory card and an external memory device such as HDD, or sending to other data processing devices 21 via communication lines.

The laser printer 20 is provided with laser light sources emitting respectively red, green and blue laser beams, illuminates photographic paper with the laser beams after modulating them according to the image recording data input from the image processor 18, to form a latent image on the photographic paper by scanning exposure. A paper processor 22 carries out such processes as chromogenic development, bleaching-fixing, washing and drying onto the photographic paper exposed in the laser printer 20. These processes develops the latent image into a visible image on the photographic paper.

A base of the negative film is covered with an orange mask, which distinguishes the negative film from the reversal film. Because of this difference, a lighting period and lighting current of the respective color lights of LED are controlled. Concretely, for reading the reversal film, percentages of the blue and green lights are reduced while maintaining the red light unchanged.

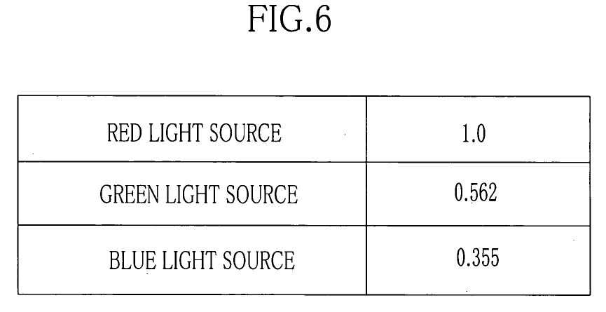

FIG. 6 shows an example of current values conducted through the LEDs for reading the reversal film. The current values to the green and blue light sources for the reversal film are 0.5 times and 0.3 times those for the negative film. Because setup algorithms for the negative and reversal films are different, like the image data on highlight and shadow is inverted, the algorithms are switched over between the negative film and the reversal film, to set up conditions suitable for the respective image data.

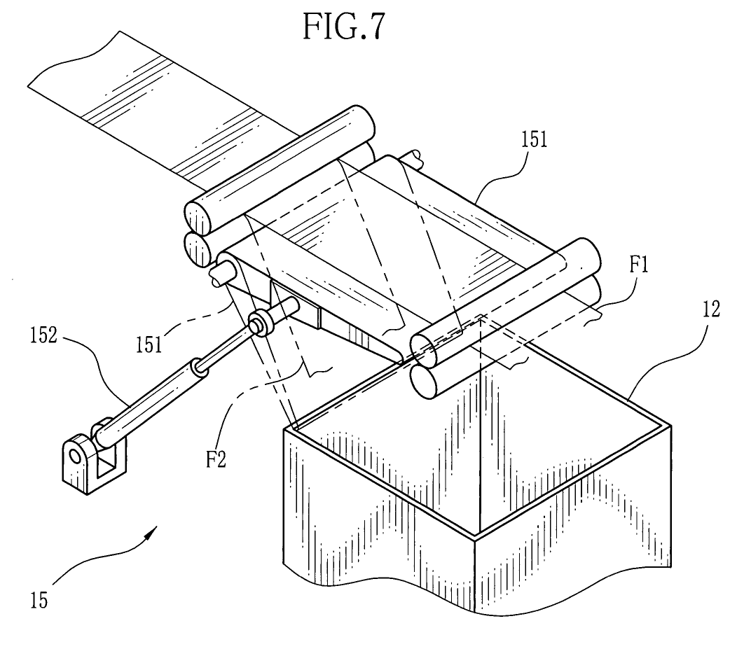

As shown in FIG. 7, the film sorter 15 is placed on the film path behind the image reading apparatus 10. The film sorter 15 is provided with a lid 151 and a driving mechanism 152. The lid 151 forms a bottom face of the film path. The driving mechanism 152 is a cylinder moving forward and backward and the move of a cylinder arm opens and closes the lid 151. The film catcher 12 is arranged obliquely downward the lid 151. When the lid 151 is open, the photo filmstrip fed to the film sorter 15 is taken in the film catcher 12 under the guidance of the lid 151.

The driving mechanism 152 is controlled by the controller 17. In the case where the next film to be sent to the image reading apparatus 10 is the negative film F1, the controller 17 orders the driving mechanism 152 to close the lid 151. So the negative filmstrip F1 is fed forward to the negative film cutter-inserter section 60. On the other hand, in the case where the next film to be sent to the image reading apparatus 10 is the reversal film F2, the controller 17 orders the driving mechanism 152 to open the lid 151. So the reversal film F2 is taken in the film catcher 12 under the guidance of the lid 151.

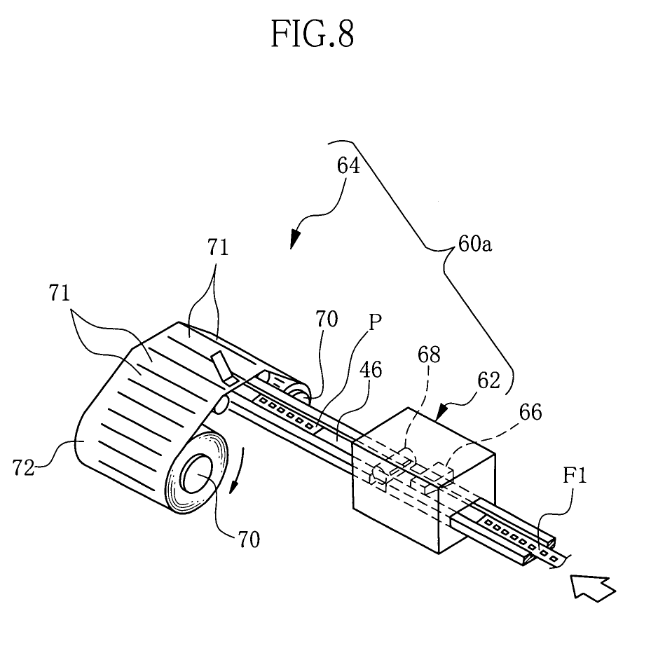

As shown in FIGS. 4 and 8, the negative film cutter-inserter section 60 consists of a cutter-inserter 60a and a cutter-inserter controller 61. The cutter-inserter 60a has a cutter section 62 located on the film path 37 behind the film sorter 15, and an inserter section 64. The cutter section 62 has a sensor 66 to recognize the number of picture frames and borders between the picture frames, and a rotary cutter 68 to cut the negative film F1 at every given number of picture frames into negative film pieces P. The negative film pieces P are conveyed along a film path 46 behind the cutter section 62 to the inserter section 64.

A preservation sheet 72 with a series of sheathes 71 made of plastic film is wound into convolutions around a pair of drums 70 in the inserter section 64. The pair of drums 70 are driven so as to position the sheath 71 successively on an extended line to the film path 46 of the negative film piece P from the cutter section 62, thereby letting the negative film pieces P be inserted one after another into the sheathes 71. The preservation sheet 72 is cut into a length corresponding to one photo filmstrip.

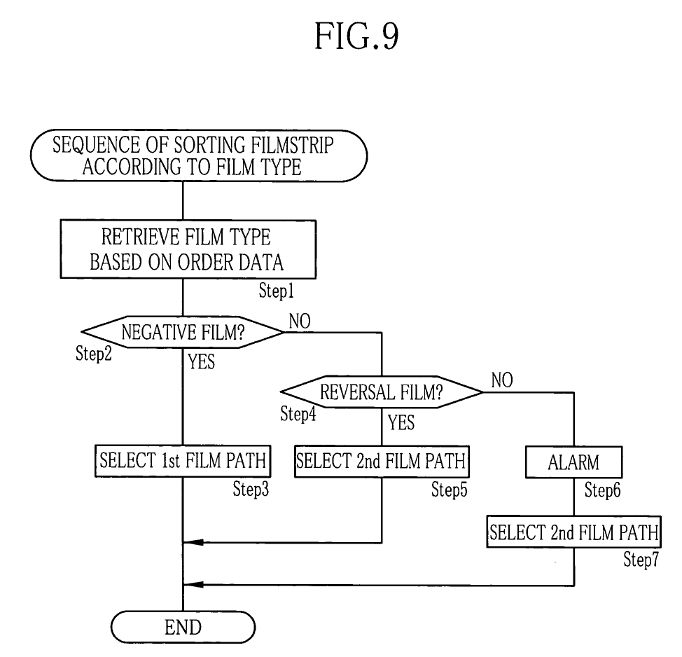

Now a sequence of sorting film according to the film type will be explained while referring to FIG. 9. The first thing to do is to retrieve the order data from the print order reception number to discriminate the film type (Step 1). The film type is judged whether to be the negative film or not (Step 2). In the case of the negative film, a first film path is selected (Step 3). In the case of the reversal film, a second film path is selected (Steps 4 and 5). If the photo filmstrip is neither the negative film nor the reversal film, or if the film type data is blank or undecipherable, the controller 17 outputs an error signal to the alarm 13 (Step 6) and the second film path is selected (Step 7).

Responding to the error signal of the alarm 13, the operator observes with naked eyes whether the photo filmstrip causing the error signal is the negative film or not. When it is not the negative film as the result of the naked-eye observation, an operation for releasing the error is carried out by an inputting means unshown in the drawings, to release only the error signal. On the other hand, when the photo filmstrip causing the error signal is the negative film as the result of the naked-eye observation, the film path is switched from the presently selected second film path to the first film path and then the operation for releasing the error is also carried out by the inputting means unshown in the drawings.

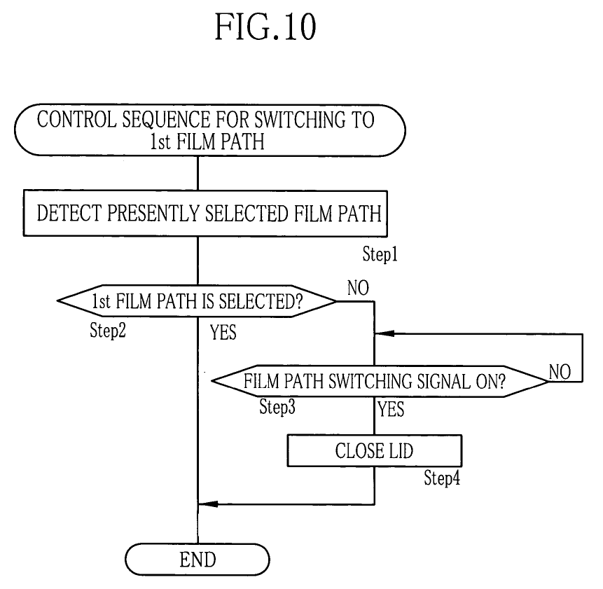

Next, a control sequence for the first film path will be explained while referring to FIG. 10. The presently selected film path is detected (Step 1). When it is the first film path, it is unnecessary to switch the film paths even though the next photo filmstrip is fed from the auto film loader 30 to the image reading apparatus 10 (Step 2). When the present film path is not the first one, the controller 17 waits till a film path switching signal is ON (Step 3). When the film path switching signal is turned ON, the controller 17 closes the lid 151 by controlling the driving mechanism 152 (Step 4). The photo filmstrip is then sent to the negative film cutter-inserter 60a.

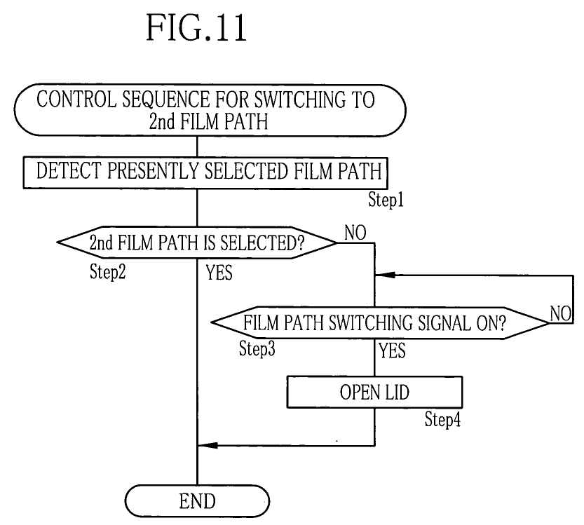

Next, a control sequence for the second film path will be explained while referring to FIG. 11. The presently selected film path is detected (Step 1). When it is the second film path, it is unnecessary to switch the film paths even though the next photo filmstrip is fed from the auto film loader 30 to the image reading apparatus 10 (Step 2). When the present film path is not the second one, the controller 17 waits till the film path switching signal is turned ON (Step 3). When the film path switching signal is turned ON, the controller 17 opens the lid 151 by controlling the driving mechanism 152 (Step 4). The photo filmstrip is then sent along the lid 151 to the film catcher.

Now a timing for the film path switching will be explained. When it is confirmed that the film as being read in the image reading apparatus 10, hereinafter referred to as a first film, is completely ejected from the image scanner 11, the film transmitter 33 starts sending the next film, hereinafter referred to as a second film, to the image reading apparatus 10. When the second film reaches the image scanner 11, the film path switching signal is output.

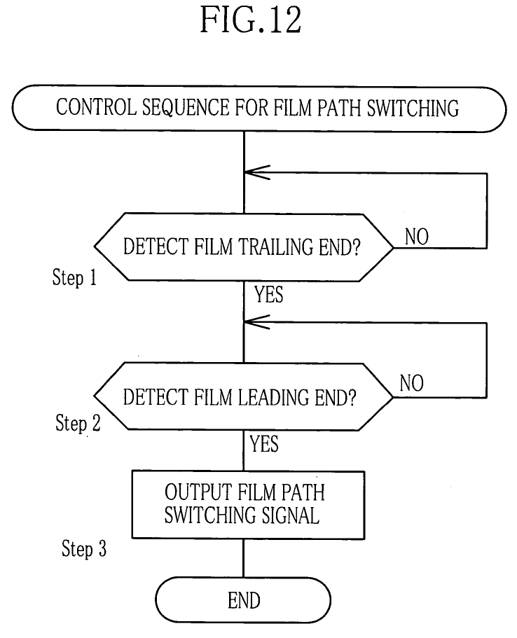

In other words, as shown in FIG. 12, the film detector D4 first detects the trailing end of the first filmstrip (Step 1). After a given period, the first filmstrip is ejected form the image reading apparatus 10. And the controller 17 demands the auto film loader controller 34 to feed out the second filmstrip. Upon receipt of the demand signal for feeding out the photo filmstrip, the auto film loader controller 34 drives the driving motor M1 to sends out the second filmstrip. Then the leading end of the second filmstrip is detected (Step 2), and the film path switching signal is output (Step 3). Because the leading end of the second filmstrip is in the image scanner 11 and has not reached the film sorter 15 at that time, the film path switching is performed properly.

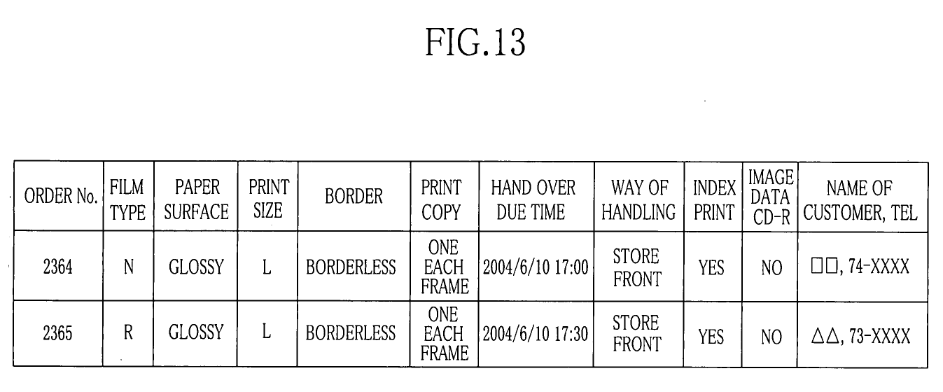

Now an overall sequence of switching the film paths according to the film type will be explained. For example, the film reception terminal 90 accepts two orders for printing a negative filmstrip and a reversal filmstrip. With the orders, an order data list as shown in FIG. 13 is generated and stored in the computer 92. A first order number is “2364”, and the data stored in association with this order number include data showing that the film type is the negative film, a print size is L size and a print copy is one each frame. A second order number is “2365” whose film type is the reversal film.

As being accepted by the film reception terminal 90, the photo filmstrip is applied at its leading end with the check tape 93 which is printed with the order number. Next the photo filmstrip is put through the film developer 80. After the development, the filmstrip is set in the film setting portion 31 of the auto film loader 30. When the controller 17 sends the demand signal to the auto film loader controller 34 for sending out the photo filmstrip, the auto film loader controller 34 sends the photo filmstrip to the image reading apparatus 10. In the present example, the film setting portion 31 has two photo filmstrips whose order numbers are “2364” and “2365” set in succession, and the photo filmstrip which is being read, the first filmstrip, has the order number “2364” and the next photo filmstrip. The second filmstrip whose order number is “2365” is stopped in the auto film loader 30 after being detected by the film detector D3.

Because the first filmstrip is the negative film F1, the control sequence for the first path is selected to close the lid 151. After the image reading, the leading end of the first filmstrip is fed to the negative film cutter-inserter section 60. The negative film cutter-inserter section 60 detects the images of the negative film, cuts the photo filmstrip between the picture frames into the negative film pieces P by a negative film cutter and inserts them in the sheaths 71 of the preservation sheet 72.

The negative film is divided into the negative film pieces P as follows. A first piece is from the leading end of the photo filmstrip to a leading edge of a first photographed picture frame. Accordingly, the first piece does not include any picture frames. The next negative film piece is cut to have the first to sixth picture frames. Therefore, the photo filmstrip for twenty-seven exposures becomes four negative film pieces each containing six picture frames and the last one negative film piece with extra three picture frames and the rest trailing end portion. When the last negative piece is inserted in the preservation sheet 72, the completion signal is fed from the cutter-inserter controller 61 of the negative film cutter-inserter section 60 to the controller 17 of the image reading apparatus 10.

The second filmstrip is the reversal film and the control sequence for the second path is selected. When the film detector D4 detects the trailing end of the first film, the controller 17 sends the auto film loader 36 the demand signal for feeding the second filmstrip to the image reading apparatus 10. The auto film loader 36 sends the reversal film whose order number is “2365” and which stops at the bar code reader D2 to the image reading apparatus 10. When the film detector D4 detects the leading end of the second film, the image reading apparatus 10 sends the film sorter 15 the film path switching signal to switch the film paths for the reversal film. The film sorter 15 controls the driving mechanism 152 to open the lid 151 in order to feed the reversal film to the film catcher 12.

Because it is usual that the number of negative filmstrips that are brought in the photo-lab is more than the number of reversal filmstrips, the total time of opening the lid 151 will be shorter than the total time of closing the lid 151. The shorter the driving mechanism 152 for driving the lid 151 is on, the longer the driving mechanism 152 lasts. For this reason, it is preferable to design so that the lid 151 opens by the ON signal of the driving mechanism 152.

In recognizing the reversal film, the image reading apparatus 10 changes the current values of the blue and green lights among respective current values of LED light sources emitting the red, blue and green lights from the light source 19 of the image scanner 11. A not-shown film transport device of the image reading apparatus 10 conveys the reversal film and stops the picture frame at an image reading position after detecting the screen position of the photo filmstrip. By emitting the red, blue and green lights of LED light sources separately, the CCD sensor 16 reads the image recorded on the stopping filmstrip. The image data read by the respective single-color lights is stored in the memory. Moreover the CCD sensor 16 reads infrared image data by illuminating the infrared light and stores it in the memory as well.

After finishing reading the image of one picture frame, the film transport device stops the next picture frame at the image reading position after detecting the next frame position of the photo filmstrip, and thus repeats the image reading. The leading end of the second filmstrip is fed gradually forward and reaches the film sorter 15. In the film sorter, the lid 151 which forms the guide surface of the film path is in the opened state. The reached leading end of the second filmstrip is guided by the opened lid 151 to be taken in the film catcher 12. Although the above described embodiment uses an area CCD sensor that reads the image while stopping the photo filmstrip at an image reading area, it is possible to apply a line CCD sensor that reads the image while moving the image reading area finely in the film lengthwise direction relative to the line CCD sensor.

Even though the negative and reversal films are set in a mix in the auto film loader 30, and are fed to the image reading apparatus 10 to read the images of the negative and reversal films, the negative filmstrips are automatically ejected to the negative film cutter-inserter section 60, and the reversal filmstrips to the film catcher 12 by the above described operations. It is possible to sort between the negative and reversal filmstrips efficiently according to the film type when they are ejected from the image reading apparatus 10, which largely improves the processing amount of the photo filmstrip per unit time.

When the bar code reader D2 cannot read the bar code, the bar code reading is carried out again. In other words, when the auto film loader controller 34 orders the bar code reader D2 to start scanning but the scanning completion signal does not return after a given time, the auto film loader controller 34 judges it as an error of reading and retries the reading. The auto film loader controller 34 orders the conveyer motor M1 to convey the film backward once until the film detector D1 detects the photo filmstrip. Then, by conveying the film forward and letting the film detector D1 detect the photo filmstrip, the auto film loader controller 34 orders the bar code reader D2 to start scanning. When the bar code 95 cannot be read even by the rereading, the auto film loader controller 34 sends an alarm signal to the alarm 35 in order to let the operator know the trouble.

When the alarm 35 goes off, the operator reads the four-digit number 94 on the check tape 93 placed at the end of the photo filmstrip in trouble of reading the bar code 95, and inputs the number 94 through the not-shown inputting device or read the bar code 95 by use of a hand-held bar code reader.

Although the data of the print order reception number is transmitted by use of the bar code and the bar code reader, it is possible to use a two dimensional bar code and a two dimensional bar code reader, or a tape embedded with a semiconductor chip and a non-contact reader, which allows recording all of the order data on a tape that is put on the individual filmstrip. Then, it becomes unnecessary to refer to the personal computer 92.

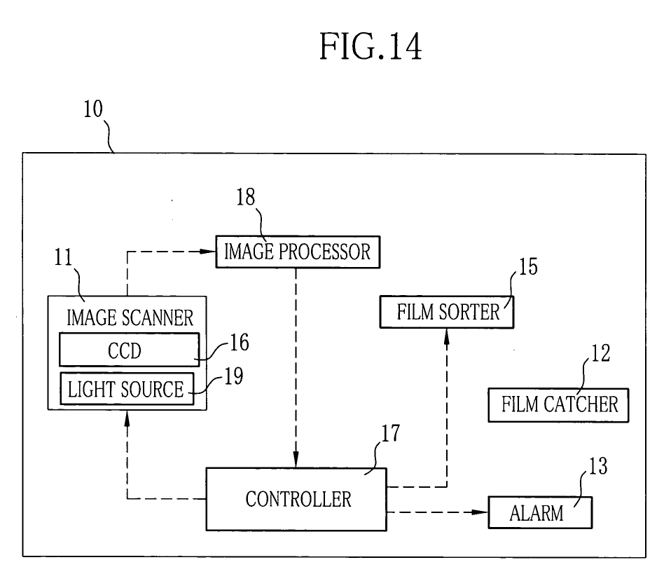

According to another embodiment shown in FIG. 14, the film type is discriminated by use of an image processor 18 in an image reading apparatus 10. In this embodiment, image data read out by an image scanner 11 is sent to the image processor 18, which discriminates between the negative films and the positive films based on the image data by use of a conventional technique, and outputs a discrimination result to a controller 17. According to the discrimination result, the controller 17 sends a film path switching signal to a film sorter 15. Because the film type is determined by the image processor 18, it is unnecessary to put the check tape 93 on the filmstrip at the order reception, or provide a bar code reader in the photo film processing system. So the photo film processing system is simplified.

Although the illustrated photo film processing system reads digital image data from the photo filmstrips and prints images based on the image data, the present invention is applicable to such a photo film processing system that uses a photo printer printing an image by projecting light through each picture frame of the filmstrip onto photographic paper. Therefore, the image reading apparatus and the photo printer are comprehensively called as film working devices.

Furthermore, although the photo film processing system of the above-described embodiment sorts reversal filmstrips out from negative filmstrips, the photo film processing system of the present invention may sort any kinds of filmstrips according to their film types.

Thus, the present invention is not limited to the above embodiments but, on the contrary, various modifications will be possible without departing from the scope of claims appended hereto.

What is claimed is:

1. A photo film processing system comprising:
an auto film loader for supplying a photo filmstrip automatically in a sequential fashion;
a film working device for reading image data or making photo prints from picture frames of said photo filmstrips;
a film type discrimination device for discriminating said photo filmstrips between a negative type and other types; and
a sorting device disposed in a position downstream of said film working device, for sorting said photo filmstrips according to film types discriminated by said film type discrimination device.

2. A photo film processing system as claimed in claim 1, further comprising a device for recording data on said filmstrips for allowing to discriminate the film type with reference to said data, and a sensor disposed in said film type discrimination device, for reading said data from said filmstrips.

3. A photo film processing system as claimed in claim 1, wherein said film type discrimination device is an image processor that can discriminates the film type based on said image data read by said film wording device.

4. A photo film processing system as claimed in claim 1, wherein said sorting device comprises a lid that forms a guide surface of a film path for guiding said photo filmstrips after being fed out from said film working device, a driving device for driving said lid to open and close, and a control device for controlling said driving device of said lid in accordance with the film type discriminated by said film type discrimination device, such that said lid is closed for the negative type filmstrips and is opened for other types of filmstrips, to distribute said photo filmstrips into two directions.

5. A photo film processing system as claimed in claim 1, further comprising a negative film cutter-inserter disposed in a position downstream of said sorting device, said negative film cutter-inserter cutting said photo filmstrips into pieces and inserting said pieces into preservation bags, wherein said sorting device feeds said photo filmstrip to said negative film cutter-inserter when said film type discrimination device discriminates said photo filmstrip as the negative type.
